(19) United States
(12) Patent Application Publication
(10) Pub. No.: US 2025/0260200 A1
(43) Pub. Date: Aug. 14, 2025

(54) HIGH SPEED AND HIGH DENSITY NEAR CHIP CONNECTOR

(71) Applicant: FCI USA LLC, Etters, PA (US)

(72) Inventors: Donald W. Milbrand, JR., Bristol, NH (US); Dean Harmon, III, Etters, PA (US); Huilin Ren, Merrimack, NH (US)

(73) Assignee: FCI USA LLC, Etters, PA (US)

(21) Appl. No.: 19/052,606

(22) Filed: Feb. 13, 2025

Related U.S. Application Data
(60) Provisional application No. 63/553,129, filed on Feb. 13, 2024.

(51) Int. Cl. H01R 13/6585; H01R 12/71; H01R 13/6592

(52) U.S. Cl. CPC H01R 13/6585; H01R 12/716; H01R 13/6592

(57) ABSTRACT

A dense, high speed pressure mount connector suitable for near chip applications. Wafers have signal conductors stamped as part of a lead frame including ground beams and a plate interconnecting them. The signal conductors are retained in insulative islands mechanically coupled to the ground beams with tails of signal conductors exposed at each island for termination to signal wires of a cable. The islands and signal conductor terminations may be enclosed, at least in part, on each of four sides with ground members, including a corrugated shield. A stiffener may be attached to the corrugated shield to resist warping of the wafer that could interfere with electrical performance. The wafers may be held, such as by welding, to a wafer retainer. The connector may include a spring-loaded protector that raises contact tips from a surface until the connector is properly positioned and forced into contact with the surface.

### CROSS-REFERENCE TO RELATED APPLICATIONS

This application claims the benefit under 35 U.S.C. § 119(e) of U.S. Provisional Application Ser. No. 63/553,129, filed Feb. 13, 2024, and titled “HIGH SPEED AND HIGH DENSITY NEAR CHIP CONNECTOR,” which is incorporated herein by reference in its entirety.

### BACKGROUND

This disclosure relates generally to an electrical connector and, more specifically, to a high speed and high density near chip connector.

Electrical connectors are used in many electronic systems. It is generally easier and more cost effective to manufacture a system as separate electronic subassemblies, such as printed circuit boards (PCBs) or chip packages, which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

Subassemblies may be joined with two-piece connectors, with one connector piece on each subassembly to be joined. In a known arrangement of this type, one subassembly may serve as a backplane. Other printed circuit boards, called “daughterboards” or “daughtercards,” may be connected through the backplane. The backplane may include many connectors that are electrically connected through the backplane. In some systems, a backplane is implemented as a printed circuit board and the connectors are connected through conducting traces in the printed circuit board. In other systems, the backplane may be implemented with cables making electrical connections among the connectors of the backplane. Daughtercards may also have connectors mounted thereon. The connectors mounted on a daughtercard may be plugged into the connectors mounted on the backplane. In this way, signals may be routed among the daughtercards through the backplane. The daughtercards may plug into the backplane at a right angle. The connectors on the daughtercards may therefore include a right angle bend and are often called “right angle connectors.”

Connectors may also be used in other configurations for interconnecting subassemblies. Sometimes, one or more smaller printed circuit boards may be connected to another larger printed circuit board. In such a configuration, the larger printed circuit board may be called a “motherboard” and the printed circuit boards connected to it may be called daughterboards. If the boards to be connected are aligned in parallel, the boards may be connected through connectors often called “stacking connectors” or “mezzanine connectors.” In other architectures, the motherboard may include a card edge connector and an edge of the daughtercard may be inserted into the card edge connector, making connections between the daughter card and the mother board.

Connectors may also be used to enable signals to be routed to or from an electronic device. A connector, called an “I/O connector,” may be mounted to a printed circuit board, usually at an edge of the printed circuit board. That connector may be configured to receive a plug at one end of a connector assembly, such that the cable is connected to the printed circuit board through the I/O connector. The other end of the connector assembly may be connected to another electronic device.

Cables have also been used to make connections within the same electronic device. The cables may be used to route signals from an I/O connector to a processor assembly or other high performance chips that are located at the interior of a printed circuit board, away from the edge at which the I/O connector is mounted. In other configurations, both ends of a cable may be connected to the same printed circuit board. The cables can be used to carry signals between components mounted to the printed circuit board near where each end of the cable connects to the printed circuit board. In yet other system configurations, cables may be used to route signals between connectors that mate with daughterboards to the vicinity of a high performance chip, which may be near the interior of a printed circuit board, whether the same or a different printed circuit board to which the connector is mounted.

Routing signals through a cable, rather than through a printed circuit board, may be advantageous because the cables provide signal paths with high signal integrity, particularly for high frequency signals, such as those above 40 Gbps using an NRZ protocol or higher bit rates, such as 56 Gbps or higher, using higher order modulation, such as PAM 4. Known cables have one or more signal conductors, which is surrounded by a dielectric material, which in turn is surrounded by a conductive layer. A protective jacket, often made of plastic, may surround these components. Additionally, the jacket or other portions of the cable may include fibers or other structures for mechanical support.

One type of cable, referred to as a “twinax cable,” is constructed to support transmission of a differential signal and has a balanced pair of signal wires embedded in a dielectric and encircled by a conductive layer. The conductive layer is usually formed using foil, such as aluminized Mylar. The twinax cable can also have a drain wire. Unlike a signal wire, which is generally surrounded by a dielectric, the drain wire may be uncoated so that it contacts the conductive layer at multiple points over the length of the cable. At an end of the cable, where the cable is to be terminated to a connector or other terminating structure, the protective jacket, dielectric and the foil may be removed, leaving portions of the signal wires and the drain wire exposed at the end of the cable. These wires may be attached to a terminating structure, such as a connector. The signal wires may be attached to conductive elements serving as mating contacts in the connector structure. The foil may be attached to a ground conductor in the terminating structure, either directly or through the drain wire, if present. In this way, any ground return path may be continued from the cable to the terminating structure.

High speed, high bandwidth cables have been used to route signals to or from processors and other electrical components that process a large number of high speed, high bandwidth signals. The cables reduce the attenuation of the signals passing to or from these components relative to what might occur were the same signals routed over a similar distance through a printed circuit board. This benefit may be most pronounced at high frequencies, such as the frequencies required to support 112 Gbps or higher data rates.

To integrate such cables into an electronic system, they may be formed into cable assemblies. Within a cable assembly, one end of the cables may be terminated to a connector, such as an I/O connector or a backplane-style connector that mates with daughterboards. The other end of the cables may be terminated to a connector, sometimes called a near chip connector, that makes connections to a printed circuit board, either directly or through mating with another connector. Direct connections may be formed with a pressure mount connector in which the mating contacts press against conductive pads on a circuit of a PCB, making separable connections when the connector is pressed against the PCB.

Despite the benefits of transmitting high speed signals through cables rather than a printed circuit board, using a cable assembly may provide little or no benefit if the near-chip connector of the cable assembly does not support the frequencies of the signals transmitted through the cables. A near chip connector necessarily entails a discontinuity between the cables and a printed circuit board. Such a discontinuity can interfere with the integrity of signals passing through the cable assembly, particularly at higher frequencies, and may limit the operating frequency of the cable assembly and therefore of the electronic system.

### SUMMARY

According to an aspect of the present disclosure, a subassembly for an electrical connector includes a first plurality of contact beams and a metal member comprising a first edge and a second plurality of contact beams extending from the first edge. The first plurality of contact beams are aligned with and interspersed with the second plurality of contact beams. The subassembly also includes an insulative material adhered to the metal member and the second plurality of contact beams.

According to another aspect of the present disclosure, a subassembly for an electrical connector includes a metal member comprising a first edge and a plurality of contact beams extending from the first edge, and a corrugated member comprising a plurality of peaks and a plurality of valleys. Valleys among the plurality of valleys are affixed to the metal member and a surface of the corrugated member facing the metal member is selectively plated with a plating material.

According to another aspect of the present disclosure, a subassembly for an electrical connector includes a first conductive member extending in a first plane, the first conductive member comprising a first edge and a first plurality of contact beams extending from the first edge in a row. The first conductive member includes a plurality of openings therethrough. The subassembly also includes a second plurality of contact beams, the second plurality of contact beams each comprising a portion of a respective contact of a plurality of contacts disposed within the plurality of openings. The second plurality of contact beams are aligned in the row with the first plurality of contact beams, and each of the plurality of contacts comprises a tail bent out of the first plane and configured for attachment of a cable. The subassembly further includes a second conductive member extending in a second plane parallel to the first plane, the second conductive member comprising a first portion affixed to the first conductive member and second portions. Respective second portions are aligned, in a direction perpendicular to the second plane, with the tail of one or more contacts of the plurality of contacts.

According to another aspect of the present disclosure, a subassembly for an electrical connector includes a ground member and a corrugated member comprising a plurality of peaks and a plurality of valleys. Valleys among the plurality of valleys are affixed to the ground member. A metal member is affixed to the corrugated member.

According to another aspect of the present disclosure, an electrical connector includes a first metal member comprising a first plurality of engagement features, a second metal member comprising a second plurality of engagement features, and a plurality of subassemblies disposed between the first metal member and the second metal member, each of the plurality of subassemblies comprising a plurality of contacts and a support member. The support member engages a respective engagement feature of the first plurality of engagement features and a respective engagement feature of the second plurality of engagement features.

According to another aspect of the present disclosure, a pressure mount electrical connector includes a housing comprising a mating face comprising an opening therein, a plurality of contacts, each comprising a compliant portion exposed in the opening of the mating face, a frame bounding, at least in part, the opening, and a spring member between the housing and the frame. The spring member biases the frame away from the housing in a direction perpendicular to the mating face.

The foregoing features may be used, separately or together in any combination in any of the foregoing embodiments.

### BRIEF DESCRIPTION OF DRAWINGS

The accompanying drawings are not necessarily drawn to scale. For the purposes of clarity, not every component may be labeled in every drawing. In the drawings:

FIG. 1A is a top perspective view of a pressure mount, near chip connector mounted to a substrate;

FIG. 1B is a bottom view of the pressure mount connector of FIG. 1A;

FIG. 2 is a partially exploded view of the pressure mount connector of FIG. 1A

FIG. 3 is an exploded view of a contact protector at the mating interface of the connector of FIG. 1A and the connector footprint on the surface of the substrate;

FIG. 4 is a top perspective view of the pressure mount connector of FIG. 1A with an outer housing hidden and cables shown partially cut away;

FIG. 5 is a partially exploded view of the pressure mount connector of FIG. 4 with a breakout showing an enlarged side view of a wafer retainer;

FIG. 6 is a top perspective view of the pressure mount connector of FIG. 4 with the cables, wafer carrier and wafer retainer hidden;

FIG. 7 is an enlarged view of a portion of the pressure mount connector of FIG. 6 with a breakout illustrating engagement of meeting contact portions of conductive elements within the connector to pads on a surface of the substrate;

FIG. 8A is a top perspective view of a wafer of pressure mount connector of FIG. 1A;

FIG. 8B is a bottom perspective view of the wafer of FIG. 8A;

FIG. 8C is a bottom perspective view of the wafer of FIG. 8B with a ground member hidden to reveal mating contact portions of signal conductors within the wafer;

FIG. 9A is a front perspective view of the wafer of FIG. 8A, sectioned along a line parallel to a row of mating contact portions;

FIG. 9B is a front perspective view of the wafer of FIG. 8A, sectioned along a line perpendicular to a row of mating contact portions;

FIG. 10 is a rear perspective view of a wafer of the pressure mount connector of FIG. 1A, sectioned through cables terminated to the wafer;

FIG. 11 is a partially exploded view of the wafer of FIG. 10;

FIG. 12 is a top, rear perspective view of the wafer of FIG. 11 with the stiffener and corrugated shield hidden and three of four cables terminated to conductive elements within the connector;

FIG. 13 is an enlarged view of the distal end of a cable terminated to signal conductors held in the wafer via an insulative over mold;

FIG. 14 is an enlarged view of a wafer of FIG. 13, with the insulative over mold hidden, with two pairs of signal conductors shown enlarged;

FIG. 15A is a top perspective view of an alternative embodiment of a stamping of a lead frame for forming the wafer of FIG. 10, configured for an alternative wire gauge;

FIG. 15B is a bottom perspective view of a stamping of a lead frame for forming the wafer of FIG. 10;

FIG. 16 is a top perspective view of the stamping of the lead frame for forming the wafer of FIG. 15B with insulative islands holding signal contacts to the ground network and tie bars severed to electrically separate the signal contacts and ground network, with one island shown enlarged;

FIG. 17 is a top perspective view of a corrugated shield stamped from a sheet of metal still attached to carrier strips; and

FIG. 18 is an enlarged view of the corrugated shield of FIG. 17 with plated surfaces indicated.

### DETAILED DESCRIPTION

The inventors have recognized and appreciated designs for near chip connectors that support very high frequencies of operation, including frequencies above 112 Gbps, and up to and beyond 224 Gbps, while meeting prevailing metrics of signal integrity. For example, the connector may provide −1 dB loss to 28 GHz; −12 dB reflections to at least 28 GHz (such as up to 40 GHz); and power sum crosstalk of less than −55 dB near-end crosstalk (NEXT), such as −60 dB (NEXT) and less than −35 dB far-end crosstalk (FEXT), such as −40 dB (FEXT). Such connectors may also support a high density of interconnects. Signal contacts associated with pairs of signals may be separated center-to-center by less than 1.0 mm, such as with a 0.6 mm contact pitch maintained in pair or other contact pitch in the range of 0.4 to 0.8 mm.

Pairs of signal conductors within a row may be separated by less than 3.5 mm center-to-center, such as with a pitch of 3.2 mm or other pitch in the range of 3.0 mm to 3.5 mm. The rows may also be separated by less than 3.5 mm, center-to-center, such as with a row pitch of 3.0 mm or other row pitch in the range of 2.7 to 3.3 mm. A connector with this density may, for example, support a connection density of 40 differential pairs per connector in an area on a printed circuit board to which the connector is mated (e.g. the connector footprint) smaller than 1,000 mm², such as less than 900 mm², or between 800 and 950 mm², in some examples. Such connectors, even with 40 differential pairs, may be small enough to be mounted on a pitch 22 mm×45.6 mm.

Connectors as described herein may enable efficient manufacture of small, high performance electronic devices, such as servers and switches. These near chip connectors support a high density of high-speed signal connections to processors and other components in the mid-board (i.e., daughterboard) region of the electronic device. The other ends of cables terminated to the connector may be connected to a connector, such as an I/O or backplane-style connector, or at another location remote from the mid-board such that the cables of a connector assembly may carry high-speed signals, with high signal integrity, over long distances, such as 6 inches or more.

The connector may support a pressure mount interface to a substrate (e.g., a PCB or semiconductor chip substrate) carrying a processor or other components processing a large number of high speed signals. The connector may incorporate features that provide a large number of pressure mount interconnection points in a relatively small volume. The connector may include a set of contact subassemblies (also called wafers) manufactured in a similar way, with the interconnection points among the different wafers being parallel but in different planes. Each set of interconnection points may be associated with one wafer.

The connector may terminate multiple cables with a contact tip respectively connecting to each signal conductor in each cable and one or more contact tips coupled to a grounding structure within the cables. For drainless twinax cable, for example, the connector may have, for each cable, two contact tips electrically coupled to the cable signal conductors and either one or two contact tips coupled to a shield around the cable signal conductors. The contact tips may, for example, be beams extending outwards along an edge of the wafer such that they are positioned to contact complementary pads on a mating structure, such as a printed circuit board. The wafers may be aligned within the connector such that the contact tips from multiple wafers are in parallel planes, which may define the mating interface of the connector.

According to exemplary embodiments described herein, any suitably sized cable conductors may be employed and coupled to a suitably sized contact tip. In some embodiments, cable conductors may have a diameter less than or equal to 32 AWG, such as between 32 AWG and 40 AWG. In other embodiments, cable conductors may have a diameter less than or equal to 27 AWG, such as between 27 and 34 AWG, for example.

In some examples, a near chip connector may be manufactured from one or more wafers. Each wafer may include multiple sets of contact tips, with each set of contact tips connecting to the same cable, such that the multiple sets of contact tips of a contact subassembly connect to multiple cables. As a specific example, the cables may be twinax cables with two signal conductors surrounded by a cable shield such that there are two signal contact tips in each set. In some examples, all of the contact tips for a wafer may be aligned in a row extending from a side of the wafer. The contact tips may be uniformly spaced across the row, or, in other examples, the spacing of contact tips within each set may be uniform, but there may be greater edge-to-edge spacing between sets of contact tips than within the sets.

Each set of contact tips may include one or more signal contact tips and one or more ground contact tips. For terminating a twinax cable, for example, each set of contact tips may include a pair of signal contact tips between two ground contact tips. The ground contact tips within a wafer may be connected through one or more conductive networks, while the signal contact tips may be electrically separated from each other and from the ground network(s).

Generally, the signal contact tips may be tips of signal conductors and the ground contact tips may be tips extending from a ground plate such that the ground contact tips may be electrically connected through the ground plate. The signal contact tips and ground contact tips may be formed as contact beams extending from a metal member (e.g., a metal sheet) and may serve as mating portions for portions of cables. The same or different metal member may be stamped to define the body of the plate and multiple sets of contact beams extending from one edge of the body of the plate, which may serve as ground contact tips. In this example, the body of the metal member forms a portion of the network interconnecting the ground contact tips.

In some examples, signal conductors (including the signal contact tips), may be stamped from the same sheet of metal as the metal member forming the ground network. The signal conductors, though mechanically separated from the ground network in the finished connector, may be held within the wafer via insulative material affixed to an intermediate portion of the signal conductors and to the metal member. The insulative material may leave the signal contact tips of the signal conductors exposed for pressure mounting to a substrate. The insulative material also may leave tails of the signal conductors exposed for attaching wires of a cable to the signal conductors. In some examples, the tail of the signal conductors may jog out of the plane of the metal plate such that they can be terminated to short signal conductors of a cable. the insulative material may support the tail so the signal conductors in this position. Alternatively or additionally, the insulative material may provide mechanical support for the cable when attached to the tails of the signal conductors. In some embodiments, the insulative material may be a plastic overmold. Insulative material may also be added closer to a second edge, opposite the edge of the metal member with the contact beams, to act as spacers or other support structures for the cables connected to the signal contact tips of the subassembly.

The wafers may be arranged within a connector for high density interconnection. According to exemplary embodiments, a wafer assembly may include a number (e.g., ten, or other number such as between 5 and 15) of wafers arranged along one dimension. Each of the wafers may include a number (e.g., four or other number such as between 3 and 6) of sets of contact beams that facilitate connection to a corresponding number (e.g., four) of cables along another dimension, perpendicular to the first.

The inventors have recognized and appreciated that approximately 4 sets (e.g. 3-5 sets) of contact beams per wafer provides a desirable compromise between density of interconnects and electrical performance. Longer wafers, even with stiffeners as described herein, tend to flex an undesirable amount, which results in unreliable connections for sets near the central portion of the wafer and can lead to signal distortion that interferes with high performance operation.

A carrier assembly may hold the wafers. The carrier assembly may include an wafer carrier to hold the wafers and a wafer retainer that facilitates more accurate positioning of the wafers in the wafer assembly and locks the wafers in place. The wafers may be held with the mating contact portions of multiple wafers aligned in a plane, which may serve as the mating interface of the connector. For mating to a PCB or other substrate, the mating interface of the connector may be pressed against the substrate.

In some examples, the wafer carrier may be an insulative part and may be molded of plastic. The wafer carrier may include partitions to separate and support the wafers. The partitions may be angled relative to the walls of the wafer carrier such that the wafers are held in an angled position within the wafer carrier. The angled position of the wafers may facilitate better connection (e.g., increased surface area of connection) between the contact beams of the wafers and the substrate (e.g. PCB, semiconductor chip substrate).

The wafer retainer may be formed with a manufacturing process that enables more precise positioning of the wafers than molded plastic parts. For example, the wafer retainer may be a stamped metal part, which may include wafer engagement features (e.g slots) that engage complementary features on the wafers. The wafer engagement features may be formed with higher precision than molded parts and may better resist deflection when placed under load for pressure mounting, either or both of which may improve the reliability of connections and may increase signal integrity through the near chip connector. The wafer engagement features of the wafer retainer, for example, may be or include slots that receive projections from the wafers. The projections, for example, may project from the stiffener and/or the metal member of the wafer. In some examples, engagement features of the wafers and of the wafer retainer may be welded or otherwise affixed to each other. A housing may cover the wafer assembly on three or more sides with an opening for the cables, such as at an open side. The housing alternatively or additionally may include an opening at the mating face through which mating contacts for signals and ground conductors are exposed for mating to a substrate.

The near chip connector may include a protector. The protector may be mounted to an exterior portion of the connector at the mating face of the connector. The contact tips of the wafers of the connector may be exposed at the mating face such that they may be pressed against pads on a substrate. The protector may be movable between an extended position in which the protector extends beyond the contact tips when the connector is not pressed against a substrate and a loaded position in which the contact tips extend beyond the protector. The protector may be biased, such as by spring loading, into the extended position. The protector may elevate the contacts of the wafer assembly prior to mating of the wafer assembly with a printed circuit board (PCB) or other substrate. When the connector is mated to the PCB and screwed down, the protector spring may be compressed to its loaded position.

According to an exemplary embodiment, the protector is a frame that bounds the mating interface of the connector. In the examples illustrated herein, the frame has a closed perimeter that bounds the mating interface on four sides. In other examples, the frame may bound the mating interface partially on each of four sides or on less than four sides.

The protector may be biased by a spring between the protector and at least one other portion of the connector housing. In some examples, the spring may be formed from a sheet of metal with spring fingers bent from it that can be compressed between the protector and the housing. The spring optionally may engage either or both of the protector and the housing to hold the protector in place relative to the housing. In other examples, one or more springs may be positioned between another component mechanically coupled to the wafers, such as the wafer carrier or wafer retainer, and the protector.

The wafers may be constructed to provide very high frequency operation. Each wafer may be built on the metal member, which may serve as a stamped lead frame. The lead frame may include ground contact tips connected by a ground network of portions of the metal member that are not cut away by the stamping. Signal conductors may be formed in the same stamping operation. Each signal conductor may have a contact beam with a signal contact tip and a tail at an opposite end configured for attachment to a wire of a cable and an intermediate portion in between.

The stamped lead frame may be plated in a contact zone of each of the contact beams. For example, matte nickel (Ni) may be applied to hard gold (Au), which is applied over Ni.

Insulative material (e.g., plastic) may hold the signal conductors in position. It may be applied to the plated lead frame. For example, areas of the metal member and the intermediate portions of the signal conductors may be overmolded. As a specific example, ground contact tips may be overmolded with islands of insulative material into which the signal conductors are partially embedded. The insulative material may hold the signal conductors with tails exposed for attachment to conductors of a cable. The tails may be held above the ground conductors and/or the metal plate from which the ground contact tips extend. In addition, insulative material may be added closer to an opposite edge of the metal member from the contact beams to hold the cables in place.

Cables may be prepared for termination with wires extending beyond the cable insulator. A cable shield may be exposed, such as by removing the cable jacket, at the end of the insulator. The wires may be attached, such as by welding, to the tails of the signal conductors. The cable shield may be in contact with the metal member, serving as a network connecting the ground contact tips. The cables may be pressed against the metal member to make a good electrical contact with the metal member. The cables may be pressed against the metal member by a corrugated shield attached to the metal member. The corrugated shield may be attached to a metal member, such as by welding. The corrugated shield may have peaks and valleys. The corrugated shield may be attached at the valleys to the metal member.

In some examples, the corrugated shield may be a part of a corrugated shield assembly. The corrugated shield assembly may include the corrugated shield and a stiffener. The corrugated shield may be formed from stainless steel stamped to have a corrugated shape with alternating peaks and valleys. The corrugated shield and stiffener may be laser welded to the metal member.

A side of the corrugated shield that faces the metal member may be selectively plated to provide a high conductivity, such as above 4×10⁶ Siemens per meter (S/m). Examples of suitable plating include hard gold, silver, palladium, or other noble plating finish. The plating may ensure electrical connection with foil or other material serving as the cable shield in the terminal area. Exemplary plating thickness may be 0.1 to 0.15 micrometers of hard gold over 1.2-5.5 micrometers of Nickel.

The stiffener of the corrugated shield assembly may be a stamped stiffener to increase stiffness of the wafer and mitigate bowing under load. The stiffener may be welded to the corrugated shield. The stiffener may include a set of feet that are mechanically secured to the metal member, such as by welding. In the examples illustrated below, the feet are adjacent the edge of the wafer through which cables exit the wafer and aid in clamping the cables to the wafer.

A ground cover may be welded on a side of the metal member that is opposite the side to which the corrugated shield assembly is attached. The stamping operation that forms signal conductors from the same metal member as the ground contact tips and ground network interconnecting the ground contact tips leaves an opening in the metal member around the signal conductors. In some examples, a second metal member may be attached to the metal member and may have portions that partially or totally fill the openings left by stamping the signal conductors. Those portions of the second metal member may act as a ground cover, covering openings in the ground network in locations that could result in a change in impedance that would disrupt signal integrity, particularly at high frequencies.

In some examples, the signal conductors of the connector may have tails that are bent out of the plane of a body of the metal member and the portions of the second metal member acting as the ground cover. The tails may be elevated out of the plane of the body of the metal member to align with the signal conductors within the cables being terminated to those signal conductors of the connector. Based on the position of the cutaway regions, the signal conductors of a cable may have the ground cover below without an intervening plate (metal member) portion.

Exemplary implementations of the foregoing and additional features are illustrated in the attached drawings.

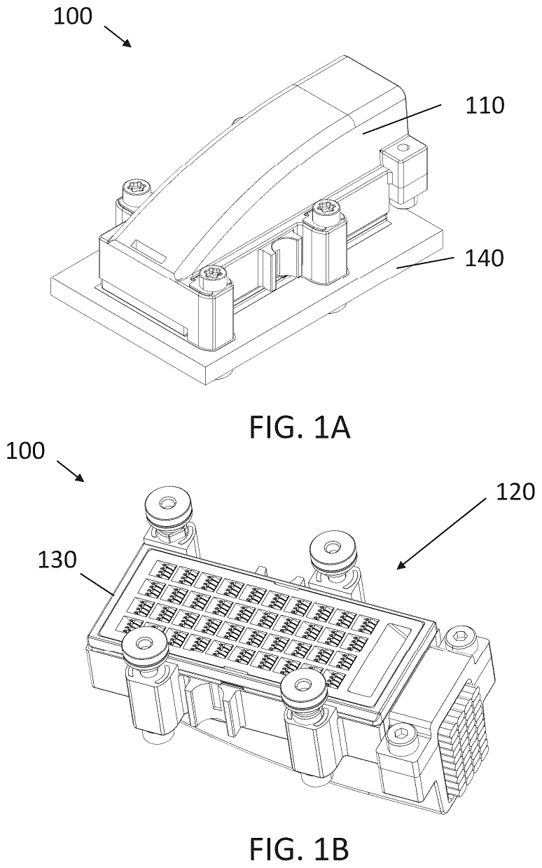

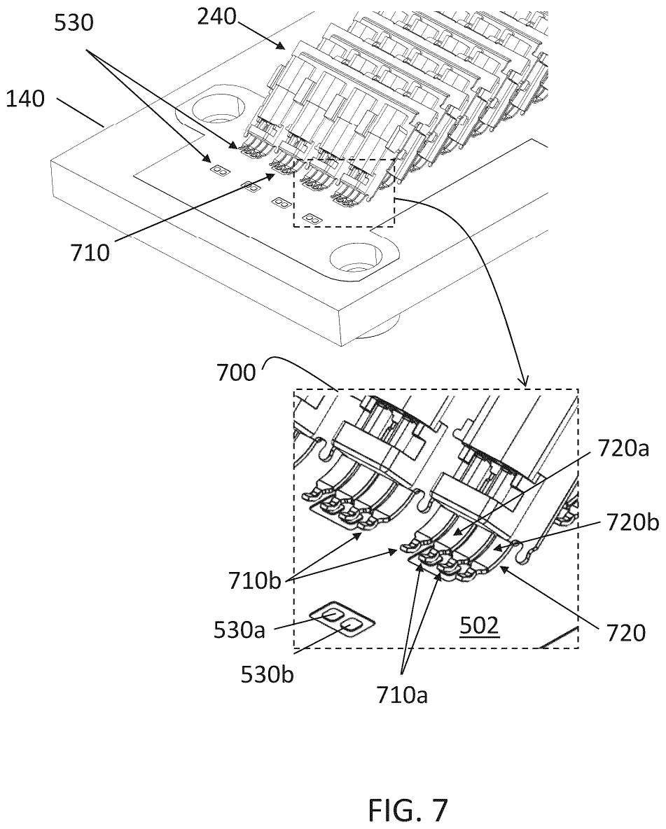

FIG. 1A is a perspective view of a connector 100 according to some embodiments detailed herein, and FIG. 1B shows a different view of the connector 100 of FIG. 1A. According to the orientations shown, FIG. 1B shows a bottom of the connector 100 shown in FIG. 1A. FIG. 1A shows a housing 110 of the connector 100 on a substrate 140. The housing 110 may be an insulative housing and, according to exemplary embodiments, may be molded of plastic. In other implementations, conductive material may be used, such as die cast metal. Although cables are not shown, the connector 100 may terminate multiple cables with a contact tip 710 (FIG. 7) associated with each conductor in each cable. The housing 110 may cover three or more sides of the components of the connector 100 and may have an open side as an opening for the cables and an opening at a mating face of the connector through which contact tips 710 are exposed for mating to substrate 140. Substrate 140 may be a printed circuit board (PCB) or may be a portion of a chip package,

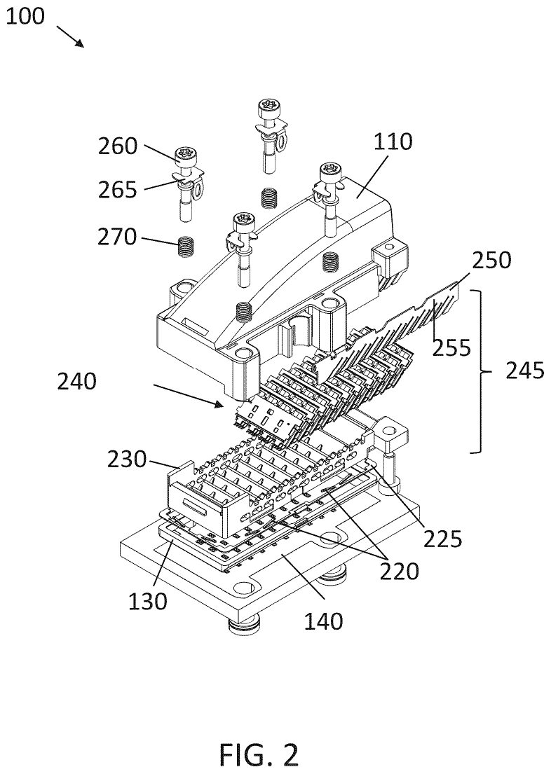

FIG. 1B shows a mating interface 120 of the connector 100 that may facilitate a pressure mount interface to the substrate 140, for example, as discussed with reference to FIG. 2. For simplicity of illustration, only a portion of substrate 140 is shown. The substrate 140 may carry processing circuitry to process a number of high speed signals, including those exchanged over cables that terminate at the mating interface 120. As detailed with reference to the several views, the connector 100 may incorporate features that provide a large number of pressure mount interconnection points at the mating interface 120 in a relatively small volume. A protector 130 is shown at the perimeter of the mating interface 120 and is further discussed with reference to FIG. 2.

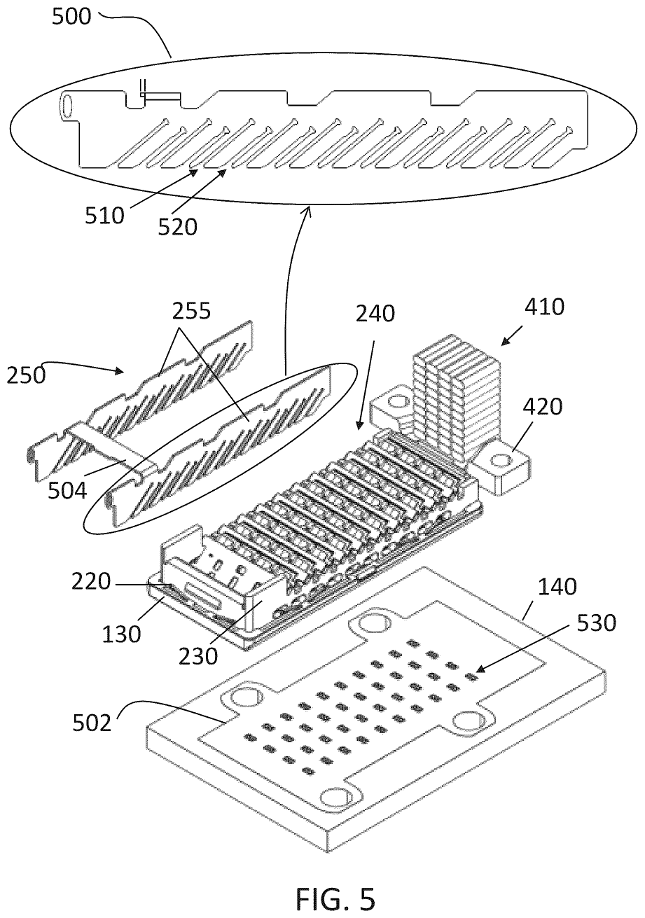

FIG. 2 is an exploded view of the exemplary connector 100 of FIG. 1A. Inside the connector housing is a wafer assembly 245. In the wafer assembly 245, wafer carrier 230 holds one or more contact subassemblies, here referred to as wafers 240. Each wafer 240 may include signal conductors and, optionally, ground conductors and associated support member. In the illustrated example, the plurality of wafers are generally planar and are stacked side by side in the wafer carriers such that the wafers are parallel to one another. The wafers are held at an angle, such as between 25 and 75 degrees, with respect to the mating face of the connector. A wafer retainer 250 may include a retaining part 255 on each side, disposed between the wafer carrier 230 and the wafers 240, to facilitate more accurately positioning the wafers 240 in the wafer assembly 245 and securing them in place. The wafer retainer 250 may be a stamped metal part with wafer engagement features 510, 520 (here shown as slots), further discussed with reference to FIG. 5, to engage complementary features on the wafers 240.

The mating interface 120 is shown in the example of FIG. 1B framed by a protector 130. As shown, the protector 130 may have a closed perimeter that bounds the mating interface 120 on four sides. In some embodiments, the protector 130 may bound the mating interface 120 partially on each of four sides or on less than four sides. As discussed with reference to FIG. 7, at least some of the contact tips 710 of the wafers 240 may be exposed at the mating interface 120 such that they may be pressed against pads (contact areas 530, FIG. 5) on substrate 140 to establish electrical contact.

One or more protector springs 220 may be disposed between the protector 130 and the housing 110, such as by being on or part of a frame 225. In some examples, the protector springs 220 and frame 225 may be formed from a sheet of metal with spring fingers bent from the sheet. The protector springs 220 may be compressed between the protector 130 and the housing 110 when connector 100 is pressed against substrate 140. The protector springs 220 may optionally engage the protector 130 and/or the housing 110 to hold the protector 130 in place relative to the housing 110. The protector 130 may be biased by the protector springs 220 such that the protector 130 may be movable between an extended position, in which the protector extends beyond the contact tips 710 when the connector 100 is not pressed against a substrate 140, and a loaded position, in which the contact tips 710 extend flush with or beyond the protector 130 to make contact with the pads of the substrate 140.

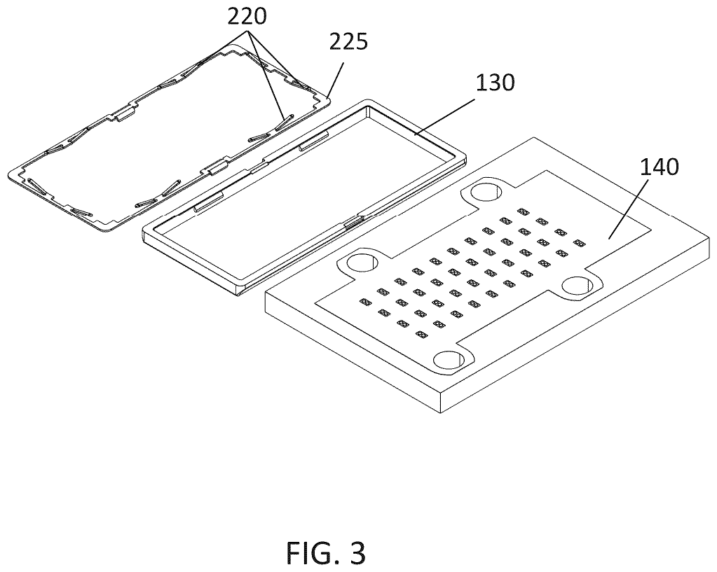

The protector 130 may be in the extended position and elevate the contact tips 710 of the wafer assembly 245 prior to mating of the connector 100 with the substrate 140. When the connector 100 is mated to the substrate 140, the protector spring 220 may be compressed to its loaded position, thereby moving the protector 130 to its loaded position. The connector 100 may be held against the substrate 140 in the mated position, as shown in FIG. 1A. In that example, the housing 110 may be affixed to the substrate 140 with hold-down screws 260, as shown. Though external hardware may alternatively or additionally be used to press connector 100 against a substrate. Screw retainers 265 and springs 270 may additionally be used to secure the components within the housing 110 to the substrate 140. FIG. 3 is an exploded view of an exemplary substrate 140, the protector 130, and the frame 225 with protector springs 220.

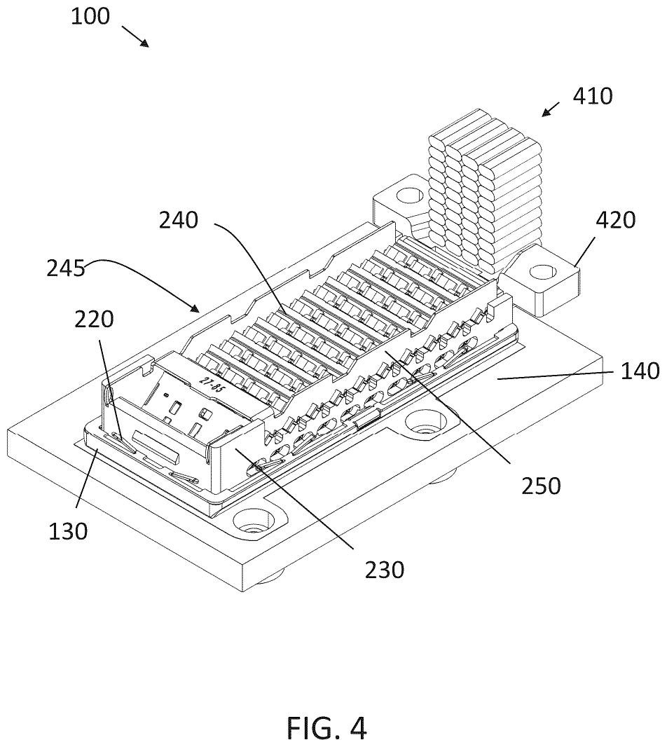

FIG. 4 is a perspective view of aspects of an exemplary connector 100 according to some embodiments. Housing 110 is hidden in this figure to reveal wafer assembly 245. Cable portions 410 are shown supported on a strain relief base 420. The connectors are shown cut away on each side of the strain relief base 420 for simplicity of illustration, but it should be appreciated that the cables extend to and are terminate at wafers and extend outside of the connector 100 for connection to other portions of an electronic system. In the exemplary illustration, each of multiple rows of the cable portions 410 corresponds to one of the multiple wafers 240 of the wafer assembly 245. In this example, each of the wafers includes four pairs of signal conductors held in a row. Four cables may extend from each row of cable portions 410 to one of the wafers 240 to connect to a row of pads on substrate 140 on which the connector 100 is pressure mounted.

FIG. 5 is an exploded view of aspects of an exemplary connector 100 according to some embodiments. Connector 100 is also depicted separated from substrate 140, such that a c connector footprint is visible. That footprint includes a ground plane 502. Contact areas 530 are formed in openings in ground plane 502. The contact areas may be pads on a surface of substrate 140 where contact tips 710 of the wafers 240 engage with signal conductors of substrate 140. These contact areas are indicated and are further discussed with reference to FIG. 7.

FIG. 5 also includes call out 500 with a side view of wafer retainer 250, providing an enlarged view of a retaining part 255. Retaining parts 255 of the wafer retainer 250 are connected via connecting member 504 and may cooperate with wafer carrier 230 to keep the wafers in place. The wafers may be held by engagement of features of the wafer with wafer engagement features of retaining parts 255. In the illustrated embodiments features on both stiffeners of the wafers and the ground members of the wafers engage the wafer engagement features, such that two types of wafer engagement features are illustrated. The enlarged view of one of the retaining parts 255 shows the stiffener engagement features 510 and ground member engagement features 520. As a specific example, both types of wafer engagement features are illustrated as slots to receive projections of wafers 240.

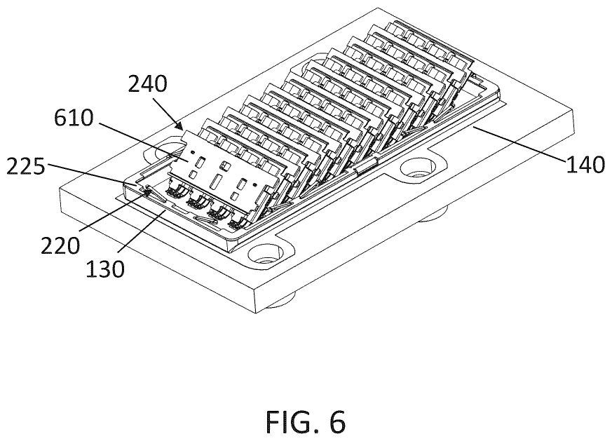

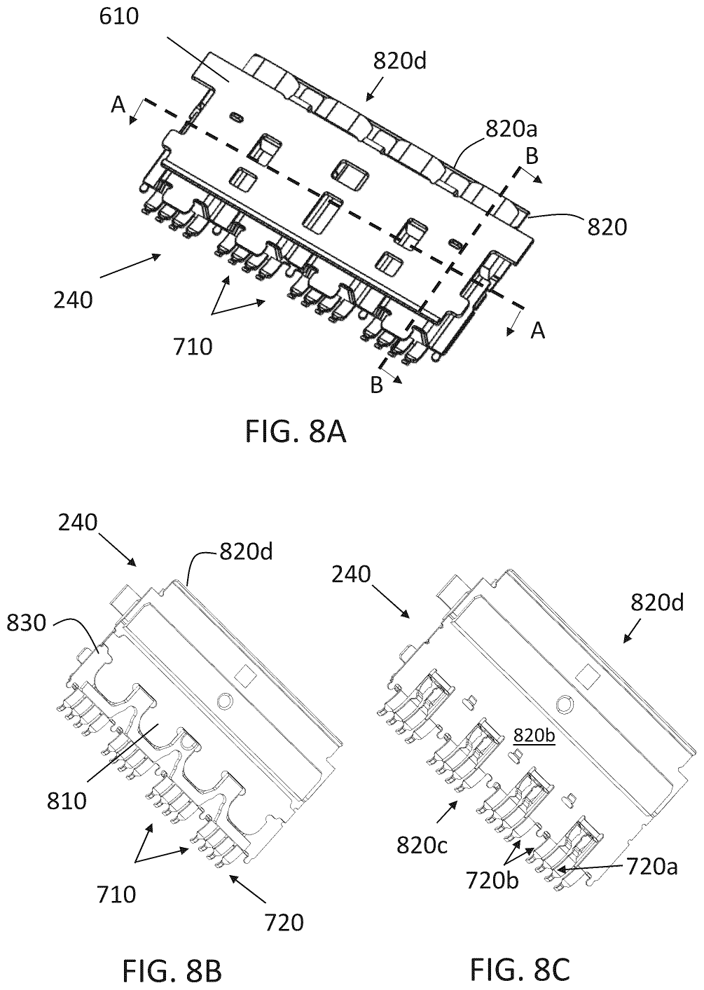

The stiffener engagement features 510 and ground member engagement features 520 may be formed with higher precision than molded parts and may better resist deflection when placed under load for pressure mounting, either or both of which may improve the reliability of connections between the wafers 240 and the substrate 140 and may increase signal integrity through the near chip connector 100. The stiffener 610 (FIG. 6) and/or ground member 810 and/or metal member 820 (FIG. 8) of the wafers 240, which engage with the stiffener engagement features 510 and ground member engagement features 520, respectively, are further discussed.

FIG. 6 is a perspective view of aspects of an exemplary connector 100 according to some embodiments. Components such as the wafer carrier 230 and wafer retainer 250 are omitted to more clearly show the wafers 240 framed by the protector 130 and the frame 225 that supports the protector springs 220. A stiffener 610 of one of the wafers 240 is visible in FIG. 6 and is further discussed with reference to FIG. 8A. Contact between the wafers 240 and the substrate 140 is further discussed with reference to FIG. 7. Components of each of the wafers 240 of the wafer assembly 245 are further discussed, for example, with reference to FIG. 11.

FIG. 7 shows part of the wafers 240 as in FIG. 6 with protector 130 and the frame 225 hidden. A wafer 240 is also hidden to better reveal a portion of the interface between the substrate 140 and wafers 240. A portion of the mating interface including signal and ground contacts for two cables is shown as an enlarged view in call out 700. In the example illustrated, each wafer 240 includes four sets of contact tips 710 extending from four sets of contact beams 720. In other embodiments, each wafer may include more or fewer sets of contact beams, but three to five sets of contact beams 720 per wafer 240 may provide a compromise between a desire for a high density of interconnects and reliable electrical performance, which may degrade as the number of interconnects increases. This degradation is because, as the wafers 240 become wider based on additional sets of contact beams 720/contact tips 710, they may be more prone to flexing and, thereby, disrupting the connections between the contact tips 710 and substrate 140.

Each set of contact tips 710 illustrates the termination of the conductors of a cable, as discussed with reference to the arrangement of cable portions 410 in FIG. 4. Each set of contact tips 710, associated with a corresponding set of contact beams 720 includes two first contact tips 710a (e.g., associated with signals), associated with first contact beams 720a, and two second contact tips 710b (e.g., associated with ground), associated with second contact beams 720b. The second contact tips 710b are on either side of the first contact tips 710a. The enlarged view more clearly shows contact areas 530 of substrate 140 with two signal pads 530a and 530b which the first contact tips 710a engage. The second contact tips 710b are a portion of ground conductors of the wafer and may press against ground plane 502.

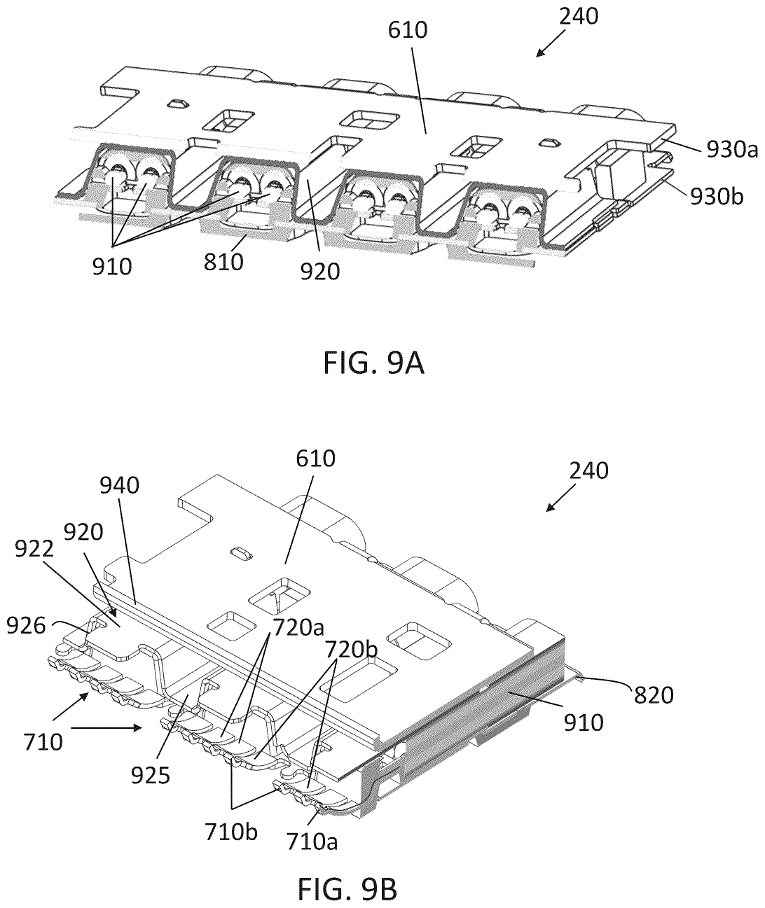

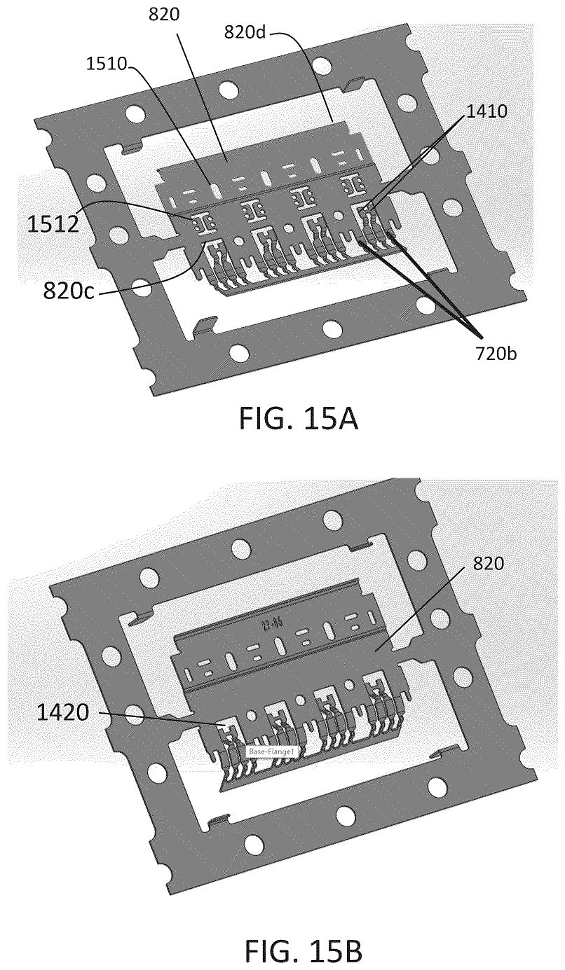

FIGS. 8A, 8B, and 8C show different aspects of an exemplary contact subassembly, here illustrated as wafer 240. FIG. 8A shows the stiffener 610 that forms one surface the wafer 240 and helps prevent warping of wafer 240, which might otherwise lead to disengagement between the first contact tips 710a and contact areas 530. On an opposite side of the wafer 240 from the stiffener 610, a metal member 820 has a first surface 820a facing upwards in the view of FIG. 8A. The metal member 820 has a first edge 820c and a second edge 820d (which may also be seen in FIGS. 15A and 15B, illustrating metal member 820). A cross-sectional view along A-A, indicated in FIG. 8A, is shown in FIG. 9A, and a cross-sectional view along B-B, indicated in FIG. 8A, is shown in FIG. 9B.

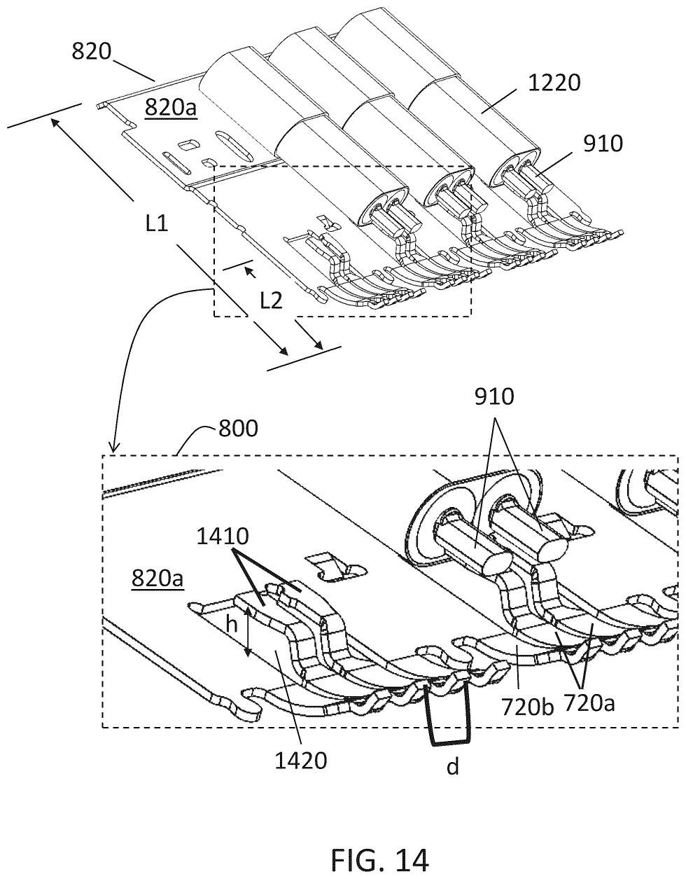

The metal member 820 may be formed as part of a stamped lead frame that may include ground contact tips (the second contact tips 710b) connected by a ground network of portions of the metal member 820 that are not cut away by the stamping. Signal conductors may be formed in the same stamping operation in which a sheet of metal is stamped to form metal member 820 and signal conductors. Each of the signal conductors may have a contact beam (e, g first contact beam 720a) with a signal contact tip (e.g. first contact tip 710a), a tail at an opposite end (1410, FIG. 14) that can be attached to a wire of a cable (910, FIG. 9A), and an intermediate portion in between. The stamped lead frame may be plated in a contact zone of each of the contact beams 720a, 720b. For example, matte nickel (Ni) may be applied to hard gold (Au), which is applied over Ni.

FIG. 8B shows an opposite surface of the wafer 240 from the surface that includes the stiffener 610. Stamping signal conductors from the same sheet of metal as metal member 820 may leave openings in metal member 820. These openings may be covered in part with a metal cover (i.e., ground cover) attached to metal member 820. In this example, the cover is formed by ground member 810. Ground member 810 is visible in FIG. 8B. Also visible in FIG. 8B is insulative material 830, which may be molded around the sets of contact beams to hold the signal conducts in the lead assembly when they are separated from the sheet of metal stamped to form the lead frame.

FIG. 8C shows the same view of the wafer 240 as in FIG. 8B with the ground member 810 and insulative material 830 omitted. Contact beams 720b extend from the first edge 820c of the metal member 820, while the first contact beams 720a are aligned with and interspersed with the second contact beams 720b but are not part of the metal member 820 like the second contact beams 720b.

FIG. 9A is a cross-sectional view along A-A, as indicated in FIG. 8A. The conductors 910 that are electrically connected to the first contact tips 710a mated to the substrate 140 are exposed in the cross-sectional view. The ground member 810 is below the conductors 910 without an intervening portion of the metal member 820, as further discussed with reference to FIG. 14.

A corrugated shield 920 is visible below the stiffener 610. Engagement features 930a, 930b on one side of the wafer 240 are indicated. The engagement feature 930a is an extension of the stiffener 610 and may engage with (e.g., slide into) the stiffener engagement feature 510 of one of the retaining parts 255 of the wafer retainer 250. The engagement feature 930b is an extension of the ground member 810 and may engage with (e.g., slide into) the ground member engagement feature 520 of one of the retaining parts 255 of the wafer retainer 250. According to some embodiments, engagement features 930a, 930b and 510, 520 may be welded or otherwise affixed to each other.

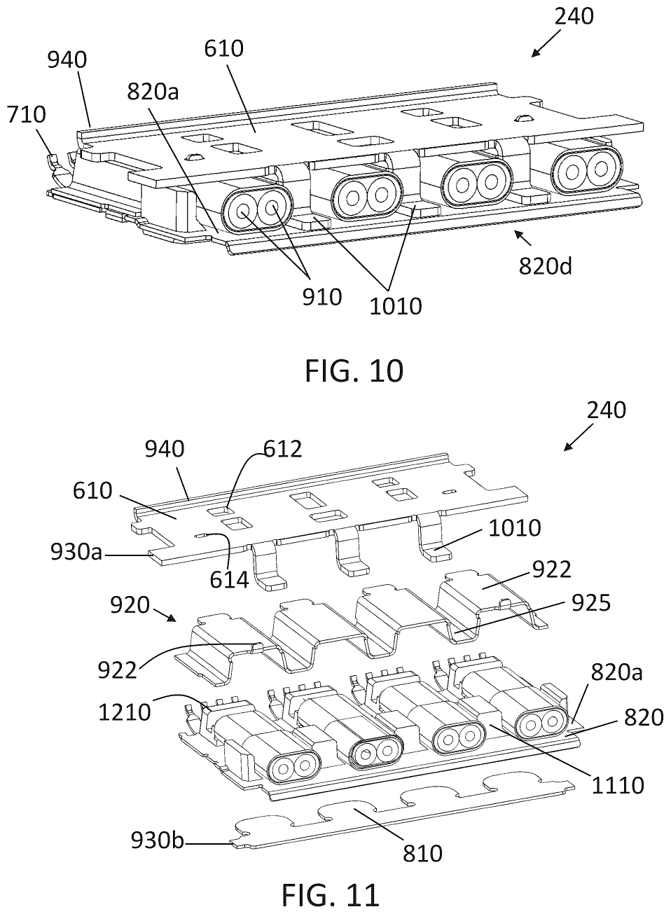

FIG. 9B is a cross-sectional view along B-B, as indicated in FIG. 8A. A conductor 910 that is electrically connected to a first contact tip 710a is exposed in the cross-sectional view. The corrugated shield 920 under the stiffener 610 may be formed from stainless steel stamped to have a corrugated shape with alternating peaks 922 and valleys 925, as shown. The stiffener 610 may have a curled edge 940 on a same side as the first edge 820c of the metal member 820. The corrugated shield 920 and stiffener 610 may be welded, forming a corrugated shield assembly that is then attached to metal member 820. The corrugated shield 920 and stiffener 610 may be laser welded to the metal member 820, for example. The valleys 925 of the corrugated shield 920 may be attached to the first surface 820a of the metal member 820, and securing features 1010 (FIG. 10) of the stiffener 610 may also be attached to the metal member 820 such as to the first surface 820a.

A side of the corrugated shield 920 that faces the metal member 820 (i.e., a corrugated shield surface facing the first surface 820a of the metal member 820) may be selectively plated to provide a high conductivity, such as above 4×10⁶ Siemens per meter (S/m). Examples of suitable plating include hard gold, silver, palladium, or other noble plating finish. The plating may ensure electrical connection with wire foil serving as the cable shield in the terminal area. Exemplary plating thickness may be 0.1 to 0.15 micrometers of hard gold over 1.2-5.5 micrometers of Nickel.

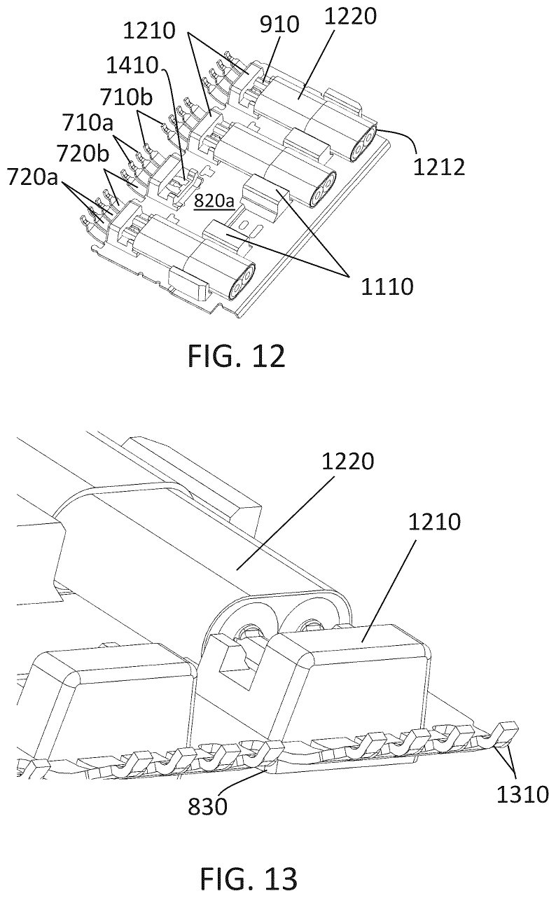

As can be seen in FIG. 9B, when the valleys 925 of corrugated shield 920 are attached to metal member 820, the peaks 922 bound termination regions, each of which may receive the end of a cable and its termination to the wafer. Corrugated shield 920 may bound each termination region on multiple sides, such as three sides. In combination with ground member 810 and/or metal member 820, the termination region may be bounded, at least partially, on four sides. The bounded termination region is more visible in FIGS. 12 and 13, in which the corrugated shield 920 is hidden.

Corrugated shield 920 may include protrusions 926 from a forward edge aligned with the signal contact tips 710a. Protrusions 926 may improve the integrity of signals passing through the wafer, such as by reducing changes of impedance along the signal paths through the wafer.

FIG. 10 is a view of an exemplary wafer 240 showing the second edge 820d of the metal member 820. Portions of cables are shown to expose the conductors 910. The securing features 1010 of the stiffener 610 are shown between the cables and mechanically secured to the metal member 820, by welding for example. The securing features 1010 may aid in clamping the cables between metal member 820 and corrugated shield 920. The clamping action may ensure suitable electrical conductivity between the cable shield and the grounding members of wafer 240. Alternatively or additionally, the locations at which this contact is provided may enable ground current flow paths that provide desirable integrity of high frequency signals passing through the wafer.

FIG. 11 is an exploded view of an exemplary wafer 240 from the same perspective as FIG. 10. This view shows insulative wire separators 1110 between the cables that align with the securing features 1010 of the stiffener 610. The insulative wire separators 1110 may hold the cables in place and aid in alignment of the conductors 910 with the first contact beams 720a. The insulative wire separators 1110 may be formed, for example, buy overmolding insulative material on metal member 820. The insulative wire separators 1110 may be formed, for example, in the same operation as insulative islands 1210, which hold the signal conductors to ground conductors. The insulative islands 1210 may be integrally formed with insulative material 830. The wire separators 1110 optionally may be integrally formed with insulative material 830. Even if formed in the same insert molding operation, wire separators 1110 need not be integrally formed with insulative material 830.

Also visible in FIG. 11 are the corrugated shield 920 and stiffener 610. In this example, stiffener 610 includes openings 612 aligned with peaks 922 of the corrugated shields. The openings may facilitate attachment of the stiffener to the corrugated shield, such as by welding. Corrugated shield 920 and/or stiffener 610 may include features to facilitate alignment of those components. These alignment features may facilitate a controlled impedance environment that enhances signal integrity through the wafer. In this example, corrugated shields 920 include tabs 928 and stiffener 610 includes slots 614, which may receive tabs 928.

FIG. 12 shows aspects of an exemplary wafer 240 without corrugated shield 920 or stiffener 610 and only three of four cables terminated signal conductors. Insulative islands 1210 adhered to portions of the second contact beams 720b and the metal member 820 are indicated. The insulative islands 1210 may be plastic, for example, and may be applied to the plated lead frame (metal member 820). The insulative islands may be, as is visible in FIG. 12, shaped to position cables 1212 so that the conductors of the cable are aligned with tails 1410 of the signal conductors. Tails 1410 may be partially embedded within insulative islands 1210 such that at least upper surfaces of tails 1410 are exposed for connection of conductors 910.

For termination of a cable to wafer, portions of the distal end of the cable may be removed. A jacket, for example, may be removed over the termination region, exposing a cable shield 1220. At the distal end of the cable, cable shield 1220 and insulator surrounding cable conductors 910 may be removed, leaving exposed cable conductors that can be attached to tails 1410. Exposed shields 1220 of cables are visible in the view of FIG. 12. The shields 1220 may be in contact from below with the metal member 820 that serves as a network connecting the second contact tips 710b. The cables 1212 may be pressed against the metal member 820 by corrugated shield 920 when it is attached to the metal member 820. With this pressure, the cable shield 1220 will make contact with metal member 820. FIG. 12 shows that the insulative island 1210 surrounds conductors 910 that extend from the exposed shields 1220 of the cables to engage with the first contact beams 720a. Insulative island 1210 may be formed by over molding insulative material on areas of the metal member 820, for example the second contact tips 710b, and portions of the signal conductors.

FIG. 13 shows a termination region for one of the cables in a wafer. In this example, the termination region includes insulative island 1210 and exposed shields of cables 1212. In an assembled wafer, this region would be bounded by the corrugated shield 920 and/or metal members 810 and/or 820. As can be seen, on each side of the insulative island 1210 a surface of metal member 820 is exposed such that valleys 925 of the corrugated shield 920 may be attached. Features such as are illustrated in FIG. 13 may facilitate a connector that is both dense and operates at high frequencies with high signal integrity.

FIG. 13 also shows bite marks 1310 that extend from the contact tips 710a, 710b and may facilitate a better electrical connection between the first contact tips 710a and contact areas 530 of substrate 140, for example.

FIG. 14 shows a portion of a lead assembly of FIG. 13 with insulative islands 1210 and insulative material 830 hidden. In this view, a connection between conductors 910 of a cable and first contact beams 720a according to some embodiments is visible. Callout 800 contains an enlarged view of a cable attachment region and the tails 1410 to which conductors 910 are attached. As can be seen in FIG. 14, the signal conductors include tails 1410 to which cables conductors 910 are attached. Tails 1410 in this example are out of the plane of the metal member 820. That is, as indicated in FIG. 14, the tails 1410 are at a height h above the metal member 820. The tails 1410 are aligned with openings 1420 in the metal member 820. In the illustrated example, the tails 1410 are above the openings. Ground member 810 may be shaped and positioned such that the ground member 810 may be below at least a portion of the openings 1420. That is, the conductors 910 of the cables may have the ground member 810 below without an intervening portion of the metal member 820.

In the example of FIG. 14, the length L2 of the signal conductors is short relative to the length L1 of metal member 820. L2, for example, may be less than half the length of L1 or is some embodiments less than 35% or less than 30% or within the range of 25 to 50%, in other examples. It is theorized that such dimensions contribute to high frequency performance of the connector.

The distance d between first contact tips 710a may be less than or equal to 3.5 millimeters.

FIG. 15A is a top perspective view of an alternative embodiment of a stamping of a lead frame for forming the wafer 240 of FIG. 10, configured for an alternative wire gauge (for connection to tails 1410). The metal member 820 may include holes 1510, which may allow material for the insulative wire separators 1110 to flow through. Compliant segments 1512 may be cut into the metal member 820. The compliant segments 1512 may facilitate connection to the exposed shields of cables 1212.

FIG. 15B is a bottom perspective view of the stamping of a lead frame for forming a wafer 240 of FIG. 10. The embodiment shown in FIG. 15B does not include the compliant segments 1512.

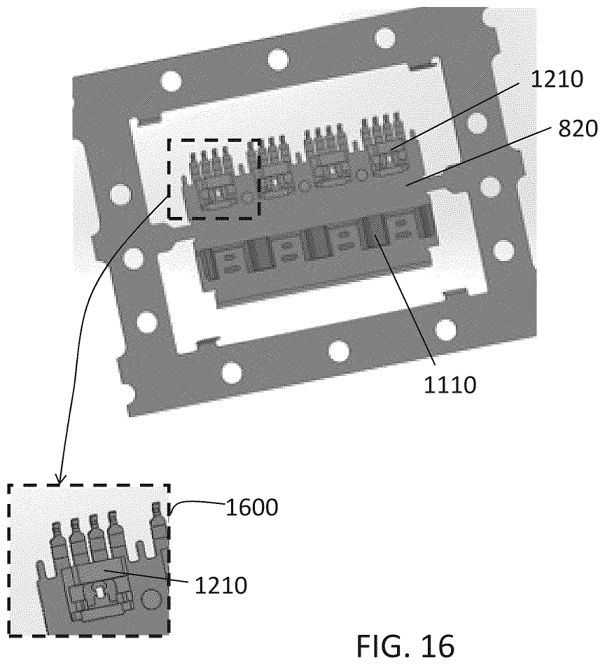

FIG. 16 is a top perspective view of the stamping of the lead frame for forming the wafer of FIG. 15B with insulative islands 1210 holding signal contacts to the ground network and tie bars severed to electrically separate the signal contacts and ground network, with one island 1210 shown enlarged in call out 1600.

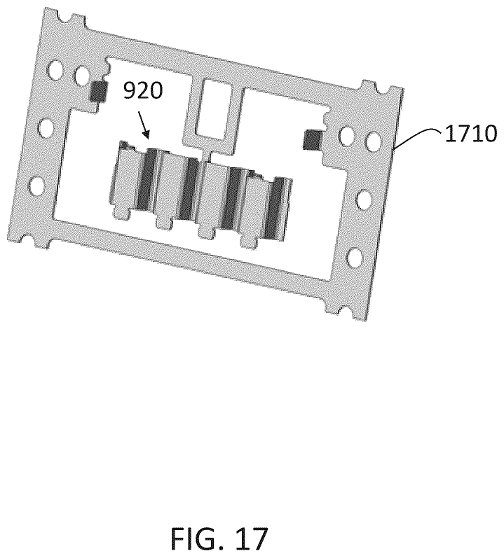

FIG. 17 is a top perspective view of a corrugated shield 920 stamped from a sheet of metal 1710 still attached to carrier strips.

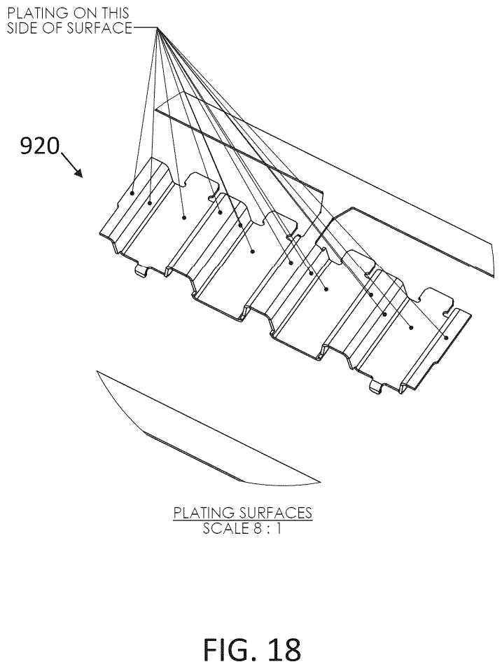

FIG. 18 is an enlarged view of the corrugated shield 920 of FIG. 17 with plated surfaces indicated.

In a first example, a subassembly for an electrical connector may include a first plurality of contact beams, and a metal member comprising a first edge and a second plurality of contact beams extending from the first edge. The first plurality of contact beams are aligned with and interspersed with the second plurality of contact beams. Insulative material may be adhered to the metal member and the second plurality of contact beams.

Optionally, the subassembly may also include a plurality of contacts and a plurality of cables. Each of the first plurality of contact beams may include a first portion of a contact of the plurality of contacts. Each of the plurality of contacts may include a second portion, and each of the plurality of cables may include at least one conductor attached to the second portion of the contact of the plurality of contacts.

Optionally, the second portion of each of the plurality of contacts is non-planar with a surface of the metal member.

Optionally, the second portion of each of the plurality of contacts is offset by a height from the surface of the metal member.

Optionally, subassembly also includes insulative material adhered to the metal member adjacent to cables of the plurality of cables.

Optionally, the first portion of the contact is plated with gold over nickel (Ni).

Optionally, each of the plurality of cables includes an exposed shield pressing against a first surface of the metal member, and the subassembly also includes a ground member affixed to a second surface of the metal member, opposite the first surface.

Optionally, the metal member is selectively cut to form the second portion of each of the plurality of contacts.

Optionally, the second portion of each of the plurality of contacts is bent out of a plane formed by a remainder of the metal member.

Optionally, the subassembly also includes a ground cover affixed to the metal member on an opposite surface of the metal member as the insulative material. The ground cover is below the second portion of each of the plurality of contacts without an intervening portion of the metal member therebetween.

Optionally, each of the plurality of cables comprises two conductors attached to the second portion of a pair of adjacent contacts of the plurality of contacts.

Optionally, the first portion of the pair of adjacent contacts associated with each of the plurality of cables is separated by a center-to-center distance of 3.5 millimeters or less.

Optionally, the metal member comprises a second edge, opposite the first edge, and a length of the metal member from the second edge to ends of the second plurality of contact beams extending from the first edge of the metal member is longer than a length of each of the plurality of contacts.

Optionally, the insulative material adhered to the metal member and the second plurality of contact beams is formed as a plurality of insulative islands.

Optionally, the subassembly includes a corrugated shield attached to the metal member. Portions of the metal member exposed between the plurality of insulative islands are attached to valleys of the corrugated shield.

In a second example, a subassembly for an electrical connector includes a metal member including a first edge and a plurality of contact beams extending from the first edge, and a corrugated member including a plurality of peaks and a plurality of valleys. Valleys among the plurality of valleys are affixed to the metal member and a surface of the corrugated member facing the metal member is selectively plated with a plating material.

Optionally, the plating material is gold.

Optionally, the plating material has a thickness of approximately 0.13 micrometers over Nickel with a thickness of approximately 1.27-5.08 micrometers.

Optionally, the plating material is silver or palladium.

Optionally, the surface of the corrugated member is selectively plated outside the valleys.

Optionally, the surface of the corrugated member is selectively plated at the valleys.

Optionally, the subassembly includes a plurality of cables, wherein each of the cables is connected to one or more of the plurality of contact beams.

Optionally, each of the plurality of cables comprises an exposed shield arranged on a first surface of the metal member, the first surface of the metal member facing the surface of the corrugated member.

Optionally, each of the plurality of peaks of the corrugated member presses the exposed shield of one of the plurality of cables into the first surface of the metal member.

In a third example, a subassembly for an electrical connector includes a first conductive member extending in a first plane, the first conductive member comprising a first edge and a first plurality of contact beams extending from the first edge in a row. The first conductive member includes a plurality of openings therethrough. The subassembly also includes second plurality of contact beams, the second plurality of contact beams each comprising a portion of a respective contact of a plurality of contacts disposed within the plurality of openings. The second plurality of contact beams are aligned in the row with the first plurality of contact beams, wherein each of the plurality of contacts comprises a tail bent out of the first plane for attachment of a cable. The subassembly also includes a second conductive member extending in a second plane parallel to the first plane, the second conductive member comprising a first portion affixed to the first conductive member and second portions. Respective second portions are aligned, in a direction perpendicular to the second plane, with the tail of one or more contacts of the plurality of contacts.

Optionally, the first portion of the second conductive member is formed as a plurality of feet to be mechanically secured to the first conductive member.

Optionally, the subassembly a plurality of cables between the first conductive member and the second conductive member. Each of the plurality of cables is connected to one or more of the plurality of contacts.

Optionally, each of the plurality of feet of the second conductive member is between adjacent ones of the plurality of cables.

Optionally, the first portion of the second conductive member is affixed to the first conductive member on a side of the first conductive member that is opposite a side from which the first plurality of contact beams and the second plurality of contact beams extend.

Optionally, the second conductive member includes a plurality of openings therethrough.

Optionally, the second conductive member includes a curled edge.

In a fourth example, a subassembly for an electrical connector includes a ground member and a corrugated member comprising a plurality of peaks and a plurality of valleys. Valleys among the plurality of valleys are affixed to the ground member. The subassembly also includes a metal member affixed to the corrugated member.

Optionally, the metal member is affixed to the peaks of the corrugated member.

Optionally, the metal member includes a body with a first edge and a second edge.

Optionally, the metal member has a curled edge at the first edge.

Optionally, the corrugated member extends past the curled edge.

Optionally, the metal member has feet extending from the second edge to the ground member that are mechanically secured to the ground member.

Optionally, the subassembly includes four cables between the corrugated member and the ground member, wherein each of the feet is between adjacent ones of the cables.

Optionally, the subassembly has four sets of contact tips, each with a pair of signal conductor contact tips and a pair of ground contact tips, wherein each of the pair of signal conductor tips is connected to one of the cables.

Optionally, the metal member is a stiffener.

Optionally, a surface of the corrugated member facing the ground member is selectively plated with a plating material.

Optionally, the plating material is gold.

In a fifth example, an electrical connector includes a first metal member including a first plurality of engagement features, a second metal member including a second plurality of engagement features, and a plurality of subassemblies disposed between the first metal member and the second metal member. Each of the plurality of subassemblies includes a plurality of contacts and a support member. The support member engages a respective engagement feature of the first plurality of engagement features and a respective engagement feature of the second plurality of engagement features.

Optionally, the plurality of contacts of the plurality of subassemblies connect with connection pads of a substrate.

Optionally, the plurality of contacts of each of the plurality of subassemblies include first contacts and second contacts.

Optionally, the first contacts of the plurality of contacts connect with cables, one or more of the first contacts connecting with one of the cables.

Optionally, the electrical connector includes a carrier to hold the plurality of subassemblies. The carrier includes partitions to separate adjacent ones of the plurality of subassemblies and openings to expose the plurality of contacts.

Optionally, the partitions are angled relative to the walls of the carrier.

Optionally, the first metal member and the second metal member slide over the first plurality of engagement features and the second plurality of engagement features, respectively, within the frame.

In a sixth example, a pressure mount electrical connector includes a housing including a mating face including an opening therein, a plurality of contacts, each comprising a compliant portion exposed in the opening of the mating face, a frame bounding, at least in part, the opening, and a spring member between the housing and the frame. The spring member biases the frame away from the housing in a direction perpendicular to the mating face.

Optionally, the spring member is compressed to its loaded position based on the housing being affixed to a substrate, the frame and the spring member being between the housing and the substrate.

Optionally, the compliant portion of each of the plurality of contacts connects to a substrate when the housing is affixed to the substrate.

Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

Terms signifying direction, such as “upwards” and “downwards” or front and back were used in connection with some embodiments. These terms were used to signify direction based on the orientation of components illustrated or connection to another component, such as a surface of a printed circuit board to which a termination assembly is mounted or the mating face of a connector. It should be understood that electronic components may be used in any suitable orientation. Accordingly, terms of direction should be understood to be relative, rather than fixed to a coordinate system perceived as unchanging, such as the earth's surface.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

What is claimed is:

1. A subassembly for an electrical connector, the subassembly comprising:
a first plurality of contact beams;
a metal member comprising a first edge and a second plurality of contact beams extending from the first edge, wherein the first plurality of contact beams are aligned with and interspersed with the second plurality of contact beams; and
insulative material adhered to the metal member and the second plurality of contact beams.

2. The subassembly according to claim 1, further comprising a plurality of contacts and a plurality of cables, wherein:
each of the first plurality of contact beams comprises a first portion of a contact of the plurality of contacts;
each of the plurality of contacts comprises a second portion; and
each of the plurality of cables comprises at least one conductor attached to the second portion of the contact of the plurality of contacts.

3. The subassembly according to claim 2, wherein the second portion of each of the plurality of contacts is offset from a surface of the metal member.

4. The subassembly according to claim 2, further comprising insulative material adhered to the metal member adjacent to cables of the plurality of cables.

5. The subassembly according to claim 2, wherein the first portion of the contact is plated with gold over nickel (Ni).

6. The subassembly according to claim 2, wherein:
each of the plurality of cables comprises an exposed shield pressing against a first surface of the metal member; and
the subassembly further comprises a ground member affixed to a second surface of the metal member, opposite the first surface.

7. The subassembly according to claim 2, wherein the metal member is selectively cut to form the second portion of each of the plurality of contacts and the second portion of each of the plurality of contacts is bent out of a plane formed by a remainder of the metal member.

8. The subassembly according to claim 7, further comprising a ground cover affixed to the metal member on an opposite surface of the metal member as the insulative material, wherein the ground cover is below the second portion of each of the plurality of contacts without an intervening portion of the metal member therebetween.

9. The subassembly according to claim 2, wherein each of the plurality of cables comprises two conductors attached to the second portion of a pair of adjacent contacts of the plurality of contacts, and the first portion of the pair of adjacent contacts associated with each of the plurality of cables is separated by a center-to-center distance of 3.5 millimeters or less.

10. The subassembly according to claim 2, wherein the metal member comprises a second edge, opposite the first edge, and a length of the metal member from the second edge to ends of the second plurality of contact beams extending from the first edge of the metal member is longer than a length of each of the plurality of contacts.

11. The subassembly according to claim 1, wherein the insulative material adhered to the metal member and the second plurality of contact beams is formed as a plurality of insulative islands.

12. The subassembly according to claim 11, further comprising a corrugated shield attached to the metal member, wherein portions of the metal member exposed between the plurality of insulative islands are attached to valleys of the corrugated shield.

13. A subassembly for an electrical connector, the subassembly comprising:
a first conductive member extending in a first plane, the first conductive member comprising a first edge and a first plurality of contact beams extending from the first edge in a row, wherein the first conductive member includes a plurality of openings therethrough;
a second plurality of contact beams, the second plurality of contact beams each comprising a portion of a respective contact of a plurality of contacts disposed within the plurality of openings, wherein the second plurality of contact beams are aligned in the row with the first plurality of contact beams, wherein each of the plurality of contacts comprises a tail bent out of the first plane and configured for attachment of a cable; and
a second conductive member extending in a second plane parallel to the first plane, the second conductive member comprising a first portion affixed to the first conductive member and second portions, wherein respective second portions are aligned, in a direction perpendicular to the second plane, with the tail of one or more contacts of the plurality of contacts.

14. The subassembly according to claim 13, wherein the first portion of the second conductive member is formed as a plurality of feet configured to be mechanically secured to the first conductive member.

15. The subassembly according to claim 14, further comprising a plurality of cables between the first conductive member and the second conductive member, wherein each of the plurality of cables is connected to one or more of the plurality of contacts, and each of the plurality of feet of the second conductive member is between adjacent ones of the plurality of cables.

16. The subassembly according to claim 14, wherein the first portion of the second conductive member is affixed to the first conductive member on a side of the first conductive member that is opposite a side from which the first plurality of contact beams and the second plurality of contact beams extend.

17. The subassembly according to claim 13, wherein the second conductive member includes a plurality of openings therethrough or a curled edge.

18. A subassembly for an electrical connector, the subassembly comprising:
a ground member;
a corrugated member comprising a plurality of peaks and a plurality of valleys, wherein valleys among the plurality of valleys are affixed to the ground member; and
a metal member affixed to the corrugated member.

19. The subassembly according to claim 18, wherein the metal member is affixed to the peaks of the corrugated member.

20. The subassembly according to claim 18, wherein the metal member includes a body with a first edge and a second edge, the metal member has a curled edge at the first edge, the corrugated member extends past the curled edge.

21. The subassembly according to claim 20, wherein the metal member has feet extending from the second edge to the ground member that are mechanically secured to the ground member, and the subassembly further comprises four cables between the corrugated member and the ground member, wherein each of the feet is between adjacent ones of the cables.

22. The subassembly according to claim 21, wherein the subassembly has four sets of contact tips, each with a pair of signal conductor contact tips and a pair of ground contact tips, wherein each of the pair of signal conductor tips is connected to one of the four cables.

23. The subassembly according to claim 18, wherein a surface of the corrugated member facing the ground member is selectively plated with a plating material, and the plating material is gold.
